(19) United States
(12) Patent Application Publication
(10) Pub. No.: US 2018/0093571 A1
(43) Pub. Date: Apr. 5, 2018

(54) BRAKING TORQUE BLENDING SYSTEM AND METHOD

(71) Applicant: Faraday&Future Inc., Gardena, CA (US)

(72) Inventors: Thomas Jackson HALL, White Lake, MI (US); Matt K. LUBBERS, Manhattan Beach, CA (US)

(73) Assignee: Faraday&Future Inc., Gardena, CA (US)

(21) Appl. No.: 15/283,176

(22) Filed: Sep. 30, 2016

(51) Int. Cl. B60L 7/26; B60T 8/1761; B60T 8/171

(52) U.S. Cl. CPC B60L 7/26; B60T 8/17616; B60T 2270/604; B60T 2270/10; B60T 2270/602; B60T 8/171

(57) ABSTRACT

A braking control method and device for a vehicle are disclosed. According to certain embodiments, the device may include a controller configured to: detect a panic braking event initiated by a user; activate regenerative braking to decelerate the vehicle; monitor an amount of friction braking generated by a friction braking system of the vehicle; monitor rotational speeds of one or more wheels of the vehicle; and adjust an amount of the regenerative braking based on the amount of the friction braking and the rotational speeds of the one or more wheels. The device may further include at least one actuator for applying the adjusted amount of the regenerative braking.

### TECHNICAL FIELD

The present disclosure relates generally to a braking torque blending system and method for a vehicle, and more particularly, to a system and method for decelerating the vehicle by blending braking torques generated by a regenerative braking system and a friction braking system, in response to a panic braking event initiated by an operator of the vehicle.

### BACKGROUND

During a panic stop of a vehicle, a driver's natural reaction is to depress the brake pedal, with the hope to draw the maximum capacity of the vehicle's braking system to decelerate the vehicle. As such, the stopping time and distance of the vehicle depend on the ability of the driver to generate force on the brake pedal and the ability of the braking system to convert the force into vehicle deceleration. However, studies show that drivers often do not step on the brake pedal quickly and/or hard enough to stop the vehicle in case of emergency. Moreover, the response time of the conventional friction braking system, e.g., hydraulic braking system, is limited by the time required by the brake fluid to transmit brake pressure to pistons mounted to the wheels. In particular, if a leak occurs in a hydraulic brake line, the brake fluid may take even longer to reach the pistons, which causes precious time lost in the event of a traffic accident.

In addition, during a panic stop, it is often critical to precisely and instantaneously modulate the braking torque in response to the change of vehicle and/or road conditions, such as wheel slip, system malfunctions, change of slipperiness of the road surface, etc. However, the slow response of the hydraulic braking system makes it hard to precisely control the braking torque. Moreover, the uncontrolled torque generation by the hydraulic braking system often causes the vehicle to lose stability during a panic stop.

Therefore, it is desirable to quickly and preciously control the braking torque in case of emergency. The disclosed brake blending system is directed to mitigating or overcoming one or more of the problems set forth above and/or other problems in the prior art.

### SUMMARY

One aspect of the present disclosure is directed to a braking control device for a vehicle. The device may include a controller configured to: detect a panic braking event initiated by a user; activate regenerative braking to decelerate the vehicle; monitor an amount of friction braking generated by a friction braking system of the vehicle; monitor rotational speeds of one or more wheels of the vehicle; and adjust an amount of the regenerative braking based on the amount of the friction braking and the rotational speeds of the one or more wheels. The device may further include at least one actuator for applying the adjusted amount of the regenerative braking.

Another aspect of the present disclosure is directed to a vehicle. The vehicle may include regenerative braking system, a friction braking system, one or more sensors configured to generate sensor data, and a controller in communication with the regenerative braking system, the friction braking system, and the sensors. The controller may be configured to: detect a panic braking event initiated by a user; activate the regenerative braking system to generate an amount of regenerative braking; monitor an amount of friction braking generated by the friction braking system; determine rotational speeds of one or more wheels based on the sensor data; and adjust an amount of the regenerative braking based on the amount of the friction braking and the rotational speeds of the one or more wheels.

Yet another aspect of the present disclosure is directed to a computer-implemented method for decelerating a vehicle. The method may include detecting a panic braking event initiated by a user. The method may also include activating regenerative braking to decelerate the vehicle. The method may also include monitoring an amount of friction braking generated by a friction braking system of the vehicle. The method may also include monitoring rotational speeds of one or more wheels of the vehicle. The method may also include adjusting an amount of the regenerative braking based on the amount of the friction braking and the rotational speeds of the one or more wheels. The method may further include controlling at least one actuator to apply the adjusted amount of the regenerative braking.

### BRIEF DESCRIPTION OF THE DRAWINGS

FIG. 1 is a block diagram of a braking control system for decelerating a vehicle, according to an exemplary embodiment;

FIG. 2 is a block diagram of a powertrain controller used in the braking control system of FIG. 1, according to an exemplary embodiment;

FIG. 3 is a schematic diagram illustrating a braking torque blending process performed by the braking control system of FIG. 1, according to an exemplary embodiment;

FIG. 4 is a schematic diagram illustrating an exemplary torque curve of an electric motor;

FIG. 5 is a block diagram of a braking control system for decelerating a vehicle, according to an exemplary embodiment; and

FIG. 6 is a flowchart of a braking control method for decelerating a vehicle, according to an exemplary embodiment.

### DETAILED DESCRIPTION

This disclosure is generally directed to a braking control method and system for decelerating a vehicle 10. It is contemplated that vehicle 10 may be an electric vehicle, a fuel cell vehicle, a hybrid vehicle, or a conventional internal combustion engine vehicle. Vehicle 10 may have any body style, such as a sports car, a coupe, a sedan, a pick-up truck, a station wagon, a sports utility vehicle (SUV), a minivan, or a conversion van. Vehicle 10 may include at least a pair of front wheels and a pair of rear wheels. Vehicle 10 may be configured to be all wheel drive (AWD), front wheel drive (FWR), or rear wheel drive (RWD). Vehicle 10 may be configured to be operated by an operator occupying the vehicle, remotely controlled, and/or autonomous. For illustrative purpose only, the disclosed method and system will be explained as being implemented to decelerate vehicle 10 in response to a panic stop and/or minimum distance/time stop commanded by an operator of vehicle 10 in case of emergency. However, it is contemplated that the disclosed method and system can be applied in any braking scenario, such as when the requested amount of braking is moderate or small, or when an emergency stop is automatically initiated by the vehicle without human input. Further, the disclosed method may be employed to reduce vehicle stopping distance and/or time, for the purpose of improving vehicle performance and/or market differentiation (e.g., better stopping distance during a car magazine review).

Vehicle 10 may include both a regenerative braking system (RBS) and a friction braking system for providing the necessary braking torques (namely, regenerative braking torques and friction braking torques) to decelerate vehicle 10. In certain embodiments, depending on the manner of the operator in depressing a brake pedal, vehicle 10 may determine that the operator has commanded a panic stop and/or minimum distance/time stop. In response to the determination, the RBS and the friction braking system may collaborate to generate a maximum combined braking torque at the fastest rate, to stop vehicle 10 in minimum distance and time.

Compared to the friction braking system, the RBS generates a smaller maximum braking torque but at a faster rate. Moreover, the torque generated by the RBS can be more preciously controlled. Therefore, in the disclosed embodiments, the RBS may be relied on to decelerate vehicle 10 before the torque generated by the friction braking system is fully developed. Subsequently, as the friction braking torque ramps up, the regenerative braking torque may be closely modulated to ensure the stability of vehicle 10. For example, when wheel slip occurs, the regenerative braking torque may be reduced or eliminated to prevent wheel lock. If the wheel slip is severe, an anti-lock braking system (ABS) may also be activated to modulate the friction braking torque. This way, the regenerative braking torque and the friction braking torque can be intelligently blended to quickly stop vehicle 10 in a stable manner.

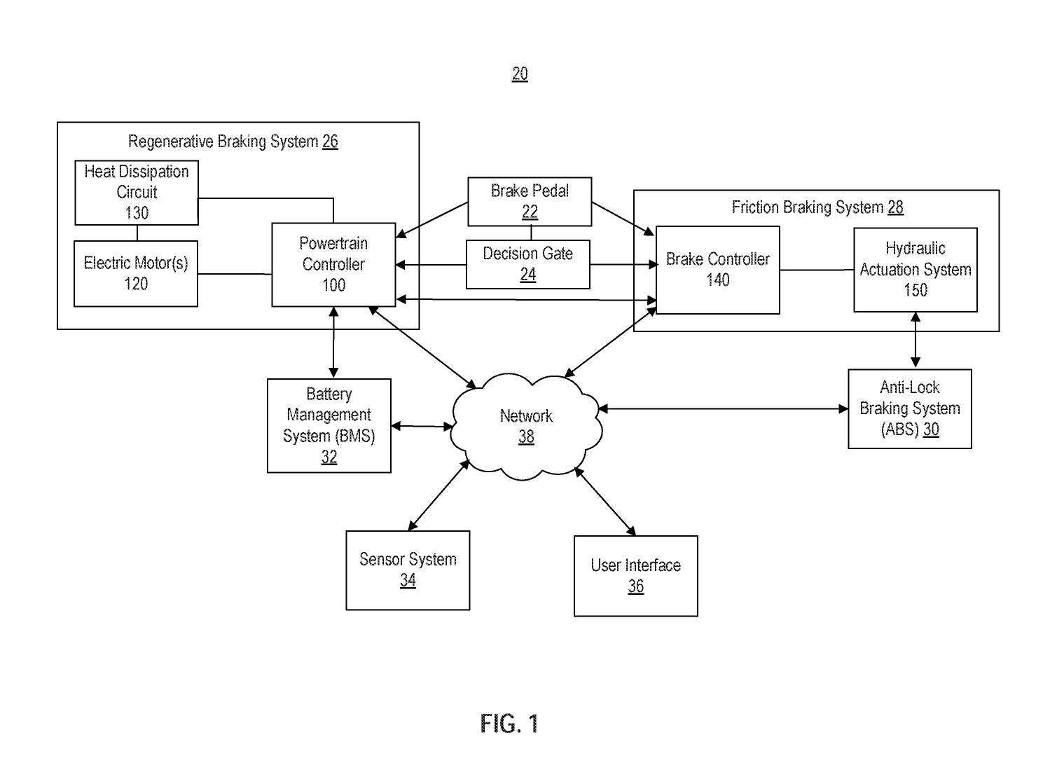

Next, the detailed operations and features of the disclosed method and system will be described in connection with the accompanying drawings. FIG. 1 is a block diagram of a braking control system 20 employed by vehicle 10, according to an exemplary embodiment. Referring to FIG. 1, system 20 may include one or more of a brake pedal 22, a decision gate 24, a RBS 26, a friction braking system 28, an anti-lock braking system (ABS) 30, a battery management system (BMS) 32, a sensor system 34, a user interface 36, and a network 38.

An operator may depress brake pedal 22 to decelerate vehicle 10. Brake pedal 22 may be configured to generate a signal indicative of movement information of brake pedal 22. The movement information may include the displacement (i.e., the amount of depression) of brake pedal 22, the moving speed of brake pedal 22, and/or the acceleration/deceleration of brake pedal 22. Thus, the movement information may reflect the operator's manner of depressing brake pedal 22, such as how hard and/or how fast the operator depresses brake pedal 22.

By interpreting the operator's manner of depressing brake pedal 22, system 20 may determine whether the operator has commanded a panic stop and/or minimum distance/time stop. Optionally, a dedicated decision gate 24 may be used to determine whether the operator has initiated a panic stop and/or minimum distance/time stop based on the movement information of brake pedal 22. For example, decision gate 24 may include logic circuitry configured to interpret the signal generated by brake pedal 22, and compare the displacement and/or moving speed of brake pedal 22 to predetermined thresholds. Upon determination that the displacement and/or moving speed exceed the predetermined thresholds, decision gate 24 may output a signal to inform RBS 26 (i.e., powertrain controller 100) and friction braking system 28 (i.e., brake controller 140) that the operator has initiated a panic stop and/or minimum distance/time stop.

In some embodiments, decision gate 24 may be omitted from system 20. Instead, the signal generated by brake pedal 22 may be directly supplied to powertrain controller 100 and brake controller 140, both of which may be configured to determine whether the operator has initiated a panic stop and/or minimum distance/time stop based on the movement information of brake pedal 22.

In addition to brake pedal 22, user interface 36 may be provided to allow the operator to initiate a panic stop and/or minimum distance/time stop. User interface 36 may be configured to receive input from the operator and transmit the input to powertrain controller 100 and/or brake controller 140. For example, user interface 36 may include an “emergency stop” button, which can be pushed by the operator to signal a panic stop and/or minimum distance/time stop request to system 10. The use of an “emergency stop” button (or switch) enables powertrain controller 100 and/or brake controller 140 to detect a panic stop and/or minimum distance/time stop request without determining the manner of the operator in depressing brake pedal 22. In some embodiments, user interface 36 may have a display including an LCD, an LED, a plasma display, or any other type of display, and provide a Graphical User Interface (GUI) presented on the display for user input and data display. For example, the “emergency stop” button may be configured to be a virtual icon shown on the GUI. To allow the operator to quickly respond to an emergency situation, user interface 36 may be installed in a location easily reachable by the operator, such as on the dashboard or the steering wheel.

RBS 26 converts the kinetic energy of vehicle 10 into another type of energy, for example, electric energy. RBS 26 may include one or more electric motors 120. When RBS 26 is activated during a braking event, electric motors 120 operate as generators to convert the kinetic energy of vehicle 10 into electric energy stored in an energy storage device, for example, a battery pack of vehicle 10. Meanwhile, electric motors 120 provide regenerative braking torques to the wheels to slow down vehicle 10. In exemplary embodiments, RBS 26 may also include a powertrain controller 100 configured to control the operation of electric motors 120. For example, as described in more detail below, powertrain controller 100 may adjust the amount the regenerative braking generated by electric motors 120.

In the disclosed embodiments, various numbers of electric motors 120 may be arranged to provide traction and regenerative braking torques to the same or different wheels of vehicle 10. For example, vehicle 10 may use a single electric motor 120 to drive the front axle, i.e., the front wheels. Alternatively, vehicle 10 may include two electric motors 120, each of which may be used to drive an individual front wheel, i.e., the front right wheel and the front left wheel, respectively. With these motor configurations, the front wheels may be braked by both regenerative braking and friction braking, while the rear wheels are braked solely by friction braking. Similarly, one or more electric motors 120 may be used to provide traction and regenerative braking torques to the rear wheels.

In some embodiments, vehicle 10 can be switched among the AWD, FWD, and/or RWD modes, as needed. For example, vehicle 10 may be initially in the FWD mode, with front wheels 12 being driven and braked by one or more electric motors 120. When vehicle 10 is commanded to switch to the AWD mode, powertrain controller 100 may engage the same one or more electric motors 120, or additional electric motors 120, to the rear axle, such that rear wheels 14 may also be driven and braked by electric motors 120. As such, powertrain controller 100 may control when certain wheels can be applied with the regenerative braking torque.

In some embodiments, when wheels 12, 14 are coupled with different electric motors 120, powertrain controller 100 may apply different magnitudes of regenerative braking torques to different wheels by controlling the respective electric motors 120. For example, powertrain controller 100 may individually control the different electric motors 120, to not only adjust the magnitude of torque but also the direction of the torque (i.e., traction or braking) on each wheel.

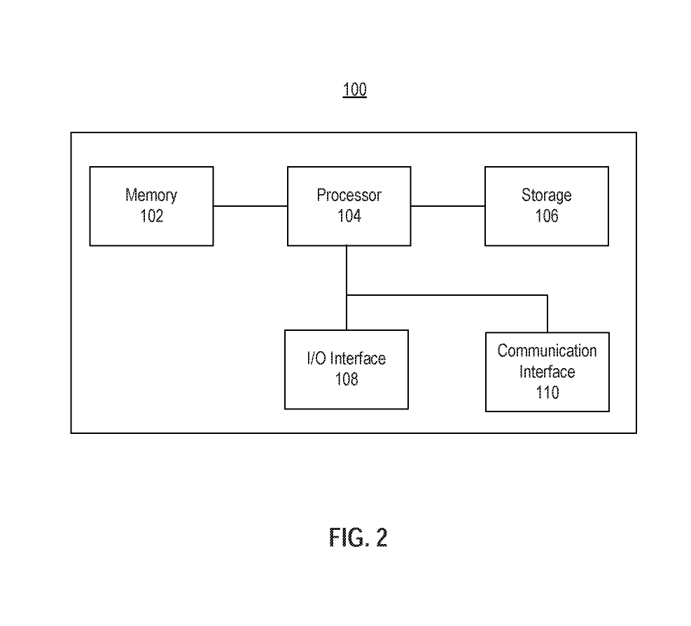

FIG. 2 is a block diagram of powertrain controller 100, according to an exemplary embodiment. As shown in FIG. 2, powertrain controller 100 may include, among other things, a memory 102, a processor 104, a storage 106, an input/output (I/O) interface 108, and a communication interface 110. At least some of these components of powertrain controller 100 may be configured to transfer data and send or receive instructions between or among each other.

Processor 104 may include any appropriate type of general-purpose or special-purpose microprocessor, digital signal processor, or microcontroller. Processor 104 may be configured as a separate processor module dedicated to generating and adjusting an amount of regenerative braking in response to an input of the vehicle operator and/or the real-time operating conditions of vehicle 10. Alternatively, processor 104 may be configured as a shared processor module for performing other functions unrelated to generating the regenerative braking torque.

Processor 104 may be configured to receive data and/or signals from components of system 20 and process the data and/or signals to determine one or more conditions of vehicle 10. For example, processor 104 may receive the signal generated by brake pedal 22 via, for example, I/O interface 108. As described in more detail below, processor 104 may also receive information regarding the operation status of the battery pack from BMS 32 via, for example, communication interface 110. Processor 104 may further generate and transmit a control signal for actuating one or more components of RBS 26, such as electric motors 120.

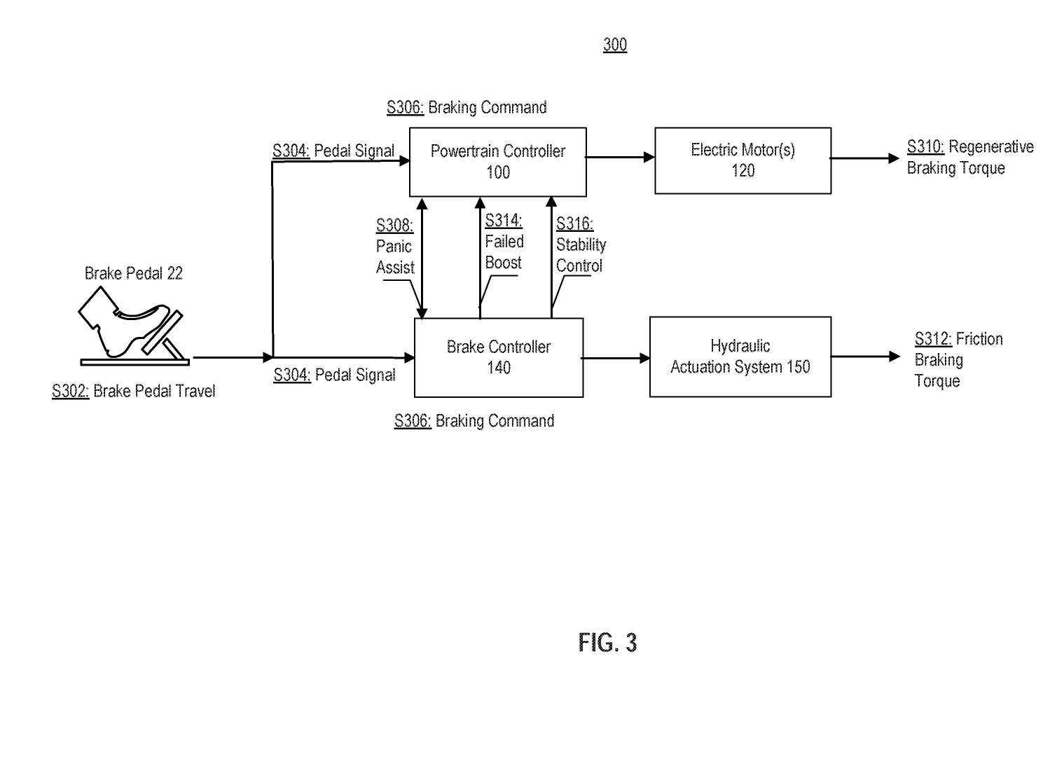

Processor 104 may execute computer instructions (program codes) stored in memory 102 and/or storage 106, and may perform functions in accordance with exemplary techniques described in this disclosure. More exemplary functions of processor 104 will be described later in relation to FIGS. 3, 4, and 6.

Memory 102 and storage 106 may include any appropriate type of mass storage provided to store any type of information that processor 104 may need to operate. Memory 102 and storage 106 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 102 and/or storage 106 may be configured to store one or more computer programs that may be executed by processor 104 to perform exemplary braking control functions disclosed in this application. For example, memory 102 and/or storage 106 may be configured to store program(s) that may be executed by processor 104 to control the bidirectional current flow between electric motors 120 and the battery pack. For example, upon determining that the operator has commanded a panic stop and/or minimum distance/time stop, processor 104 may control electric motors 120 to enter into a generator mode. As the back electromotive force (emf) in electric motors 120 builds up, the motor current may quickly reverse direction and start to charge the battery pack, so as to generate the regenerative braking torques. Moreover, processor 104 may execute the program(s) to adjust the current limit of the powertrain based on detected vehicle conditions (e.g., presence and distribution of the friction braking torques) and road conditions (e.g., slipperiness of the road), so as to modulate the amount of regenerative braking accordingly.

Memory 102 and/or storage 106 may be further configured to store information and data used by processor 104. For instance, memory 102 and/or storage 106 may be configured to store property information (e.g., operation parameters such as the torque and power curves) of each electric motor 120. These operation parameters may be tabulated into lookup tables or expressed as mathematical equations, which may be used by processor 104 to determine and adjust the magnitude of regenerative braking torque generated by each electric motor 120.

I/O interface 108 may be configured to facilitate the communication between powertrain controller 100 and other components of system 20. For example, I/O interface 108 may receive a signal generated by friction braking system 28 (i.e., brake controller 140) or sensor system 34 that indicates the magnitude of friction braking torque currently allied on each wheel, and transmits the signal to processor 104 for further processing. I/O interface 108 may also output commands to electric motors 120 or other components of the powertrain (e.g., power electronics) for adjusting the magnitudes of regenerative braking torques.

Communication interface 110 may be further configured to communicate with brake controller 140, BMS 32, sensor system 34, and user interface 36 via network 38. Network 38 may be any type of wired or wireless network that may allow transmitting and receiving data. For example, network 38 may be a wired network, a local wireless network (e.g., Bluetooth™, WiFi, near field communications (NFC), etc.), a cellular network, an Internet, or the like, or a combination thereof. Other known communication methods, which provide a medium for transmitting data are also contemplated.

Referring back to FIG. 1, the amount of regenerative braking provided by RBS 26 is limited by many factors. One such limiting factor is the State of Charge (SoC) of the battery pack. This is because the electric power generated by RBS 26 is determined by the battery voltage and the charging current that can be fed into the battery pack. Generally, when the SoC approaches its upper limit, the charging current decreases and thus the braking torque generated by the RBS 26 also decreases. Moreover, the internal resistance of the battery pack may rise exponentially when the SoC exceeds above certain level, e.g., 90%. In this case, RBS 26 needs to be disabled to avoid overheating or overcharging the battery pack. In some embodiments, to keep RBS 26 working even when the SoC of the battery pack reaches its maximum limit, RBS 26 may further include a heat dissipation circuit 130 to dissipate the regenerated energy. For example, heat dissipation circuit 130 may include one or more large resistors. When detecting that the SoC has reached a forbidden level, powertrain controller 100 may engage electric motors 120 to heat dissipation circuit 130, so that the electric current generated by electric motors 120 can be redirected to heat dissipation circuit 130.

In order to closely monitor the state of the battery pack, powertrain controller 100 may be communicatively coupled to BMS 32. BMS 32 is associated with the battery pack and configured to manage the usage and charging of the battery pack in a safe and reliable manner. In particular, BMS 32 may constantly monitor the SoC of the battery pack. For example, BMS 32 may monitor the output voltage of the battery pack, voltages of individual cells in the battery pack, current in and/or out of the battery pack, etc. BMS 32 may send information regarding the SoC to powertrain controller 100 for further processing. In some embodiments, BMS 32 may also be configured to monitor the state of health (SoH) of the battery pack, including the battery temperature. For example, when detecting that the battery pack is overheated, BMS 32 may send a warning signal to powertrain controller 100 for temporarily disabling RBS 26.

The regenerative braking torque generated by RBS 26 may not be large enough to meet the braking torque required to stop vehicle 10 in an emergency situation. In addition, as described above, the RBS 26 may not be used under certain conditions, such as with high SoC and/or high temperature of the battery pack. Therefore, RBS 26 may be combined with friction braking system 28 to produce the braking torque needed for a panic stop and/or minimum distance/time stop.

In some embodiments, friction braking system 28 may include a brake controller 140 and hydraulic actuation system 150. Hydraulic actuation system 150 uses brake fluid to apply brake pressure to wheel brakes, i.e., brake pads or shoes. In certain embodiments, hydraulic actuation system 150 may include a pressure accumulator that stores brake fluid under gas pressure, a wheel cylinder located at each wheel, and hydraulic circuits. Hydraulic circuits connect the pressure accumulator and the wheel cylinders. Brake fluid is filled in the gas accumulator, the wheel cylinders, and the brake circuits It will be understood the disclosed method may additionally be implemented by electrically generated friction braking. For example, in some embodiments, friction braking system 28 may use electrically actuated calipers instead of hydraulic calipers.

Brake controller 140 may determine, directly or via decision gate 24, the operator's brake intention based on the signal generated by brake pedal 22. In response to such determination, brake controller 140 may operate a pump to exert pressure on the brake fluid, which transmits the pressure through the brake circuits to the wheel cylinders. The pressure forces the pistons in the wheel cylinders to move forward, so as to apply brake pressure to the brake pads or shoes.

In the above-describe braking process, there is no mechanical connection between brake pedal 22 and hydraulic actuation system 150. Instead, brake controller 140 is used to control the operation of hydraulic actuation system 150 based on the movement information of brake pedal 22, so as to turn friction braking system 28 into a brake-by-wire system. As described in more detail below, the proper amount of friction braking during a panic stop and/or minimum distance/time stop is highly variable depending on the existing regenerative braking, the vehicle speed, and/or the vehicle stability (e.g., wheel slip). The brake-by-wire system enables the amount of generated friction braking to be decoupled from the actual position of brake pedal 22. This way, system 20 may flexibly blend the regenerative braking torques and the friction braking torques to stop vehicle 10 in the minimum time and distance.

In exemplary embodiments, brake controller 140 may include one or more of a memory, a processor, a storage, an I/O interface, and a communication interface, similar to the components in powertrain controller (FIG. 2). The detailed structure of brake controller 140 may be similar to powertrain controller 100 disclosed in FIG. 2, and thus is not repeated here.

In a panic stop and/or minimum distance/time stop, it is critical to apply the maximum amount of braking without leading to a wheel lock situation. With continued reference to FIG. 1, ABS 30 may be used to minimize the braking distance while retaining the steer ability during braking. For example, ABS 30 may include an electronic control unit (ECU) and one or more hydraulic valves mounted in hydraulic actuation system 150. The ECU may constantly monitor the rotational speed of each wheel. When detecting an occurrence of wheel slip, e.g., a wheel rotating significantly slower than the other wheels, the ECU may determine that a wheel lock is impending and actuate the hydraulic valves to reduce the magnitude of hydraulic pressure applied to the brake pads or shoes at the affected wheel. The ECU may perform such reduction repeatedly until the wheel slip decreases to a targeted level. Although shown as a separate module, ABS 30 may be implemented as part of friction braking system 28. For example, brake controller 140 may be configured to perform the functions consistent with the ECU and the hydraulic valves may be integrated in hydraulic actuation system 150.

To ensure the stability of vehicle 10 during a panic stop and/or minimum distance/time stop, ABS 30, as well as powertrain controller 100 and brake controller 140, need to closely monitor the state of vehicle 10 in order to preciously control the proper magnitudes of regenerative braking torque and friction braking torque exerted on each wheel. With continued reference to FIG. 1, sensor system 34 may include various sensors configured to detect the state of vehicle 10. For example, sensor system 34 may include but are not limited to: one or more wheel speed sensors configured to detect the rotational speed of the wheels; an accelerometer configured to determine the linear acceleration of vehicle 10 in the longitudinal direction, i.e., the direction parallel to the chassis of vehicle 10; a suspension sensor configured to detect the linear acceleration of vehicle 10 in a vertical direction; a steering angle sensor configured to detect the angle of the steering wheel as measured from a neutral position indicating that the front wheels are parallel and pointing straight forward; a yaw sensor configured to determine the orientation of the chassis with respect to the direction of travel; an angular rate gyro configured to measure the yaw rate of vehicle 10; and/or a weight sensor configured to detect the weight and the distribution of the weight of vehicle 10.

Operation parameters regarding the state of vehicle 10 may be determined based on the signals generated by sensor system 24. For example, powertrain controller 100 may be programed to determine the road friction coefficient (i.e., the adhesion at the tire-road interface), the longitudinal speed (i.e., the speed of vehicle 10 along the direction parallel to the chassis), the extent of wheel slip, and/or the magnitude of braking torque applied on each wheel based on signals indicative of the wheel speeds, the yaw rate, the steering angle, etc. Based on these determined operation parameters, powertrain controller 100 may further modulate the regenerative braking torques to reduce or eliminate the wheel slip. Powertrain controller 100 may also communicate the determined operation parameters to brake controller 140 and/or ABS 30 for further usage, such as for modulating the friction braking torques.

FIG. 3 is a schematic diagram illustrating a braking torque blending process 300 performed by system 20, according to an exemplary embodiment. Referring to FIG. 3, process 300 may be initiated by the operator of vehicle 10 depressing brake pedal 22 (step S302). Brake pedal 22 may then generate a signal indicative of the displacement and moving speed of brake pedal 22, and transmit the signal to powertrain controller 100 and brake controller 140 (step S304).

In step S306, powertrain controller 100 and/or brake controller 140 may translate the signal generated by brake pedal 22 into a braking command For example, powertrain controller 100 and/or brake controller 140 may compare the displacement and/or moving speed of brake pedal 22 to predetermined thresholds. If the displacement and/or moving speed of brake pedal 22 exceed the predetermined thresholds, powertrain controller 100 and/or brake controller 140 may conclude that the operator has just commanded a panic stop and/or minimum distance/time stop. Alternatively, in some embodiments, decision gate 24 may be employed to determine whether the operator has commanded a panic stop and/or minimum distance/time stop based on the signal generated by brake pedal 22, and inform powertrain controller 100 and brake controller 140 about the result of the determination.

In some embodiments, powertrain controller 100 and brake controller 140 may also inform each other that a panic stop and/or minimum distance/time stop has been commanded (step S308). For example, brake controller 140 may send a signal to powertrain controller 100, requesting RBS 26 to generate a maximum amount of regenerative braking immediately. Additionally or alternatively, powertrain controller 100 may send a signal to brake controller 140, requesting friction braking system 28 to generate a maximum amount of friction braking immediately.

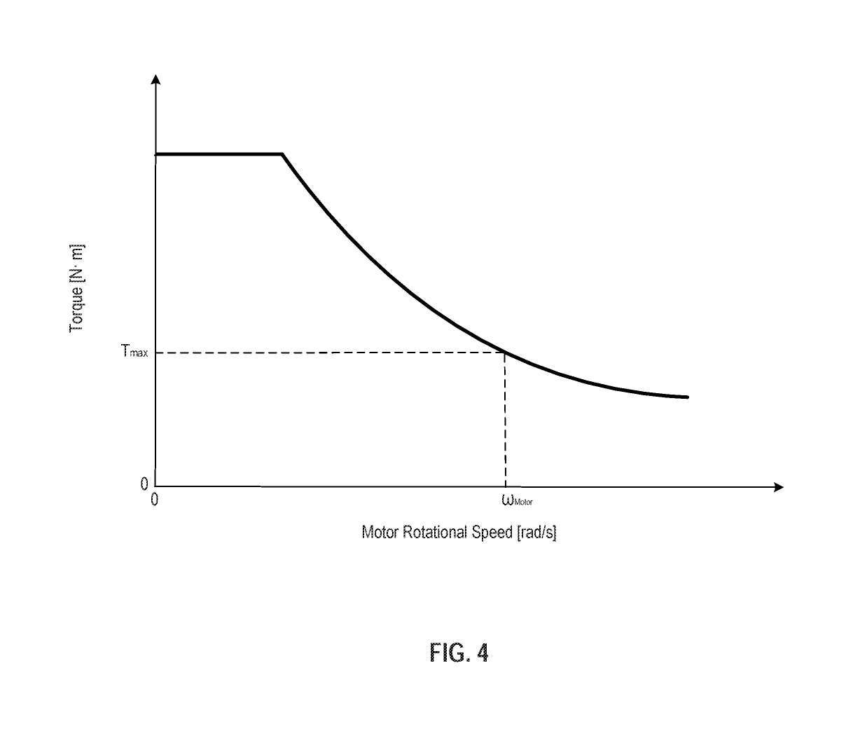

In step S310, upon determination of the panic stop and/or minimum distance/time stop, powertrain controller 100 may operate electric motor(s) 120 in generator mode to generate the maximum amount of regenerative braking. The maximum amount of regenerative braking is determined at least partially by the property of electric motor(s) 120. FIG. 4 is a schematic diagram illustrating an exemplary torque curve of an electric motor 120. Referring to FIG. 4, the x-axis represents the rotational speed of electric motor 120 operating in the generator mode, and the y-axis represents the regenerative braking torque generated by electric motor 120. According to the torque curve, the regenerative braking torque is a constant when the motor speed is below certain rotational speed, but decreases hyperbolically as the motor speed continues to increase. As such, the maximum magnitude of regenerative braking torque Tₘₐₓ that can be produced by electric motor 120 is a function of the motor speed ωₘₒₜₒᵣ.

In step 312, simultaneously to the generation of the regenerative braking torque, brake controller 140 also operates hydraulic actuation system 150 to apply friction braking on the wheels. In the disclosed embodiments, the accumulator may be set to a high pressure, so that the hydraulic pressure may be boosted in a fast rate in a panic stop and/or minimum distance/time stop. However, operation problems may arise when, for example, leaks occur in hydraulic actuation system 150, the brake system pump is worn out, and/or pump drive belt is broken. In these situations, the response time of friction braking system 28 may suffer and brake controller 140 may send to powertrain controller 100 an alert about the malfunction (step S314). This way, powertrain controller 100 may activate the regenerative braking if it has not been activated, or, if possible, further increase the amount of regenerative braking.

As the hydraulic pressure in friction actuation system 150 eventually ramps up, the combined magnitude of the regenerative braking torque and the friction braking torque may become excessive and may cause wheel slip or wheel lock. In this instance, ABS 30 may be activated to modulate the magnitude of friction braking torques. Meanwhile, brake controller 140 may send to powertrain controller 100 a message alerting powertrain controller 100 to activate features for controlling the stability of vehicle 10. For example, the message may report the current amount of friction braking, so that powertrain controller 100 may adjust the amount of regenerative braking accordingly. For example, powertrain controller 100 may reduce the amount of regenerative braking or even deactivate RBS 26, to further decrease the magnitudes of braking torques applied on the wheels.

As illustrated by process 300, the friction braking torque may be supplemented by the regenerative braking torque, so as to improve the braking torque response rate in a panic stop and/or minimum distance/time stop. Consistent with the disclosed embodiments, torque generation of electric motor(s) 120 is quick and accurate. Specifically, RBS 26 may generate braking torque within several milliseconds after receiving a command for panic stop and/or minimum distance/time stop. This is 10-100 times faster than that of friction braking system 28. The braking torques generated by electric motor(s) 120 can also be accurately determined and controlled by monitoring and adjusting the current drawn from electric motor(s) 120. Thus, before the friction braking torques are fully developed, RBS 26 may generate the regenerative braking torques to decelerate vehicle 10. Moreover, as the friction braking torques ramp up, the magnitudes of the regenerative braking torques may be preciously modulated to manage wheel slip. Accordingly, the introduction of the regenerative braking may maximize the braking torques on the wheels within a safe range. This way, the time and distance for stopping vehicle 10 can be minimized in a stable manner

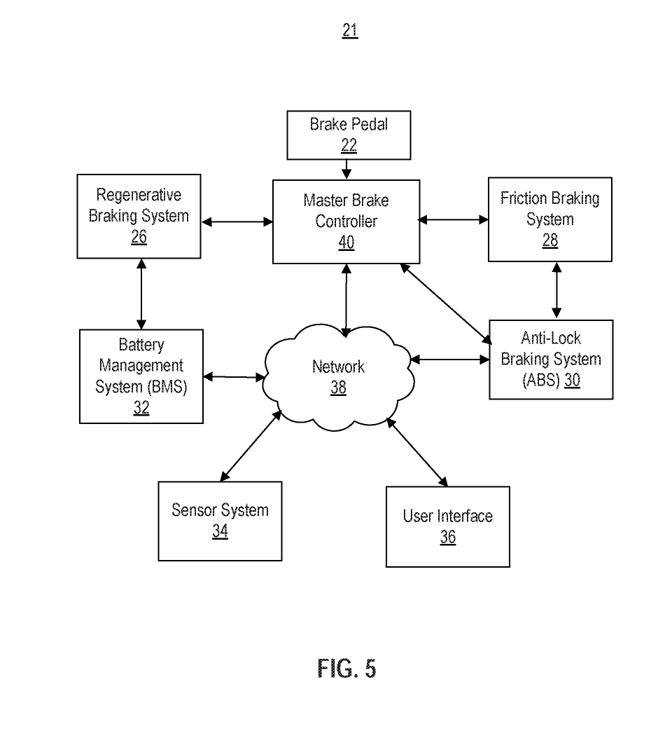

In system 20, powertrain controller 100 and brake controller 140 may be configured as separate modules to control the operations of RBS 26 and friction braking system 28, respectively. For example, powertrain controller 100 and brake controller 140 may be communicatively connected to each other, and powertrain controller 100 may be configured to adjust the amount of regenerative braking based on the amount of friction braking produced by friction braking system 28. In certain embodiments, the functions of powertrain controller 100 and brake controller 140 may be performed by one device. For example, FIG. 5 is a block diagram of a braking control system 21 for decelerating vehicle 10, according to an exemplary embodiment. Referring to FIG. 5, system 21 may include a master brake controller 40 that coordinates the operations of RBS 26, friction braking system 28, and ABS 30. For example, master brake controller 40 may receive signal generated by brake pedal 22 and translate the signal into the braking command inputted by the operator. If the signal indicates a command for a panic stop and/or minimum distance/time stop, master brake controller 40 may activate both RBS 26 and friction braking system 28. Master brake controller 40 may monitor the amounts of regenerative braking and friction braking. When the braking torque becomes excessive, master brake controller 40 may activate ABS 30 to modulate the amount of friction braking. Master brake controller 40 may also directly modulate the amount of regenerative braking. In some cases, master brake controller 40 may also allocate the required amount of braking between RBS 26 and friction braking system 28.

It is contemplated that the architecture of system 20 and 21 are for illustrative purpose. The disclosed systems may use any other proper architecture appreciated by those skilled in the art. Moreover, the disclosed system may be implemented as computer hardware, software, and/or a combination of hardware and software. The present disclosure does not limit the ways of constructing the disclosed systems.

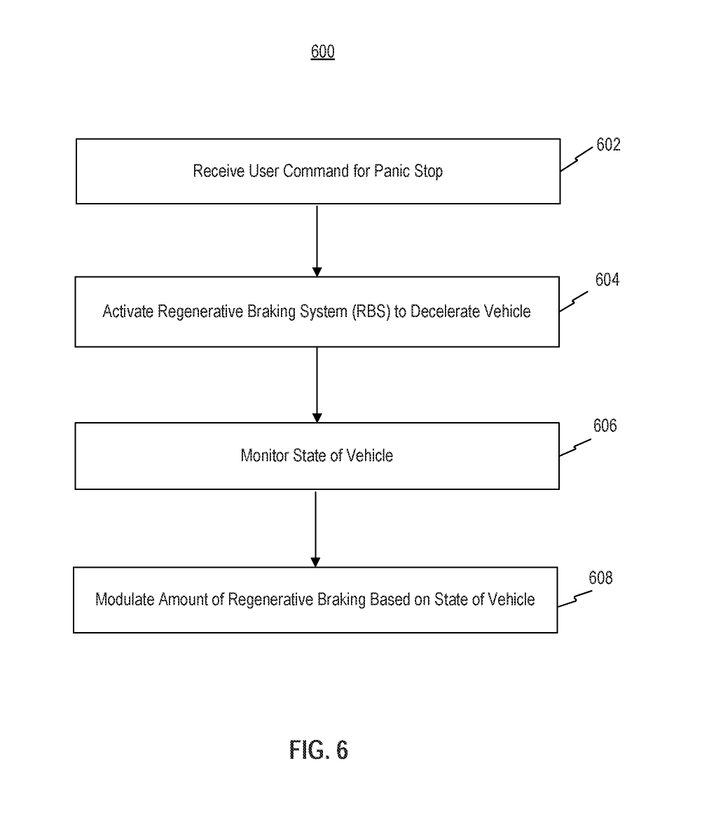

Next, referring back to system 20, a braking control method will be described. FIG. 6 is a flowchart of a braking control method 600 for decelerating vehicle 10, according to an exemplary embodiment. For example, method 600 may be performed by powertrain controller 100.

In step 602, powertrain controller 100 may receive a user command for panic stop and/or minimum distance/time stop. For example, powertrain controller 100 may receive a signal generated by brake pedal 22. The signal may contain the movement information, i.e., displacement and moving speed, of brake pedal 22. The movement information reflects the manner of the vehicle operator in depressing brake pedal 22. When the displacement and/or moving distance speed exceed certain predetermined threshold, powertrain controller 100 may determine, either directly or via decision gate 24, that brake pedal 22 was depressed by a maximum force at a maximum speed capable by the operator, and conclude that the operator has commanded a panic stop and/or minimum distance/time stop. As yet another example, powertrain controller 100 may receive a signal generated by user interface 36. If the signal indicates that the operator has just pushed an “emergency stop” button/icon on user interface 36, powertrain controller 100 may also conclude that the operator has commanded a panic stop and/or minimum distance/time stop.

In step 604, powertrain controller 100 may activate RBS 26 to decelerate vehicle 10. Powertrain controller 100 may operate electric motor(s) 120 to draw the maximum amount of regenerative braking, which is determined by several factors. For example, as described above in connection with FIG. 4, the maximum regenerative braking torque depends on the rotational speed of electric motor(s) 120. As another example, the maximum regenerative braking torque is also limited by the SoC of the battery pack. Specifically, powertrain controller 100 may determine whether the SoC equals or is above a prohibited level, which corresponds to a fully or near-fully charged state of the battery pack. If the SoC is below the prohibited level, powertrain controller 100 may activate RBS 26 without concern. Conversely, if the SoC equals or is above the prohibited level, powertrain controller 100 may conclude the battery pack cannot be charged. In this case, if system 20 includes heat dissipation circuit 130, powertrain controller 100 may couple electric motor(s) 120 with heat dissipation circuit 130 and activate RBS 26. However, if system 20 does not include heat dissipation circuit 130 or other means for dissipating the current generated by electric motor(s) 120, powertrain controller 100 may keep RBS 26 deactivated and let friction braking system 28 to handle the panic stop and/or minimum distance/time stop.

At the same time when RBS 26 is activated, friction braking system 28 is activated. However, since friction braking system 28 has a longer response time, vehicle 10 is mainly decelerated by RBS 26 at the beginning of the braking.

In step 606, powertrain controller 100 may monitor the state of vehicle 10 during the panic stop and/or minimum distance/time stop. Powertrain controller 100 may obtain various operation parameters of vehicle 10. The operation parameters may include but are not limited to: the rotational speed of each wheel; the friction braking torque applied on each wheel; the yaw rate of vehicle 10; the steering angle; the SoC of the battery pack; and/or the temperature of the battery pack. Powertrain controller 100 may receive signals indicative of these operation parameters from various sources, such as brake controller 140, BMS 32, and sensor system 34.

Powertrain controller 100 may further determine other operation parameters or features of vehicle 10 based on the received operation parameters. For example, when a wheel is rotating noticeably slower than other wheels, powertrain controller 100 may determine that a wheel slip occurs at the slower wheel. For another example, powertrain controller 100 may determine the road friction coefficient and longitudinal speed of vehicle 10 based on the wheel rotational speeds, yaw rate, and steering angle. Powertrain controller 100 may further determine the slip ratio for each wheel based on the longitudinal speed and the wheel rotational speeds.

In step 608, powertrain controller 100 may modulate the amount of regenerative braking based on the state of vehicle 10. For example, when the SoC or temperature of the battery pack reaches or exceeds a prohibited level, powertrain controller 100 may deactivate RBS 26 while let the developed friction braking torques handle the vehicle deceleration. As another example, referring to FIG. 4, as vehicle 10 decelerates, the rotational speed of electric motor(s) 120 decreases. Thus, as long as electric motor(s) 120 works in the parabolic region, powertrain controller 100 may increase the amount of regenerative braking to generate larger deceleration of vehicle 10.

As the wheels continuously respond to the joint operation of regenerative braking torques and friction braking torques, controller 100 may modulate the regenerative braking torque on each wheel based on the wheel rotational speeds and amounts of friction braking torques on each wheels, in order to maintain the stability of vehicle 10. For example, when detecting an occurrence of wheel slip, powertrain controller 100 may reduce the amount of regenerative braking. Moreover, if a wheel lock is imminent and/or ABS 30 is activated, powertrain controller 100 may deactivate RBS 26.

In some embodiments, the regenerative braking torques on some or all of the wheels can be individually adjusted, such as when different wheels are driven by different electric motors 120. As such, powertrain controller 100 may only reduce the regenerative braking torques on the wheels with slips while maintain the regenerative braking torques on other unaffected wheels. Moreover, powertrain controller 100 may distribute the regenerative braking torques among the wheels based on the friction coefficient at each wheel. For example, powertrain controller 100 may allocate more regenerative braking torques to the wheels with higher friction coefficients while allocate less regenerative braking torques to the wheels with less friction coefficients. This way, powertrain controller 100 may avoid wheel slips. In addition, powertrain controller 100 may improve the steering and/or stability of vehicle 10 during the panic stop and/or minimum distance/time stop by optimizing the distribution of regenerative braking torques between the front and rear axles.

As described above, the application of the disclosed system and method is not limited to a panic stop and/or minimum distance/time stop commanded by a vehicle operator. Blending the regenerative braking with the friction braking improves the response rate of a vehicle's braking system. Moreover, the modulation of the regenerative braking enables the braking system to exert swift and precious stability control of the vehicle. Therefore, the disclosed system and method can improve the braking performance in any braking scenario.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed braking control system and related methods. Other embodiments will be apparent to those skilled in the art from consideration of the specification and practice of the disclosed braking control system and related methods. It is intended that the specification and examples be considered as exemplary only, with a true scope being indicated by the following claims and their equivalents.

What is claimed is:

1. A braking control device for a vehicle, the device comprising:
a controller configured to:
detect a panic braking event initiated by a user;
activate regenerative braking to decelerate the vehicle;
monitor an amount of friction braking generated by a friction braking system of the vehicle;
monitor rotational speeds of one or more wheels of the vehicle; and
adjust an amount of the regenerative braking based on the amount of the friction braking and the rotational speeds of the one or more wheels; and
at least one actuator for applying the adjusted amount of the regenerative braking.

2. The braking control device of claim 1, wherein the controller is further configured to:
detect the panic braking event initiated by the user based on a signal indicative of a manner of the user in depressing a brake pedal of the vehicle.

3. The braking control device of claim 2, wherein the manner of the user in depressing the brake pedal includes at least one of a speed of depressing the brake pedal or a distance of depressing the brake pedal.

4. The braking control device of claim 1, wherein the controller is further configured to:
receive from the friction braking system a signal indicative of the panic braking event initiated by the user.

5. The braking control device of claim 1, wherein the controller is further configured to:
adjust magnitudes of regenerative braking torques applied on the one or more wheels based on the rotational speeds of the one or more wheels.

6. The braking control device of claim 1, wherein the controller is further configured to:
adjust the amount of the regenerative braking based additionally on at least one of a state of charge of a battery, a temperature of the battery, a friction coefficient between a wheel and a road surface, or operation property of an electric motor.

7. The braking control device of claim 1, wherein the controller is further configured to:
detect a wheel slip based on the rotational speeds of the one or more wheels; and
activate an anti-lock braking system (ABS) to modulate the amount of the friction braking.

8. The braking control device of claim 7, wherein the controller is further configured to:
deactivate the regenerative braking when the ABS is activated.

9. The braking control device of claim 1, wherein the controller is further configured to:
detect a wheel slip based on the rotational speeds of the one or more wheels; and
reduce the amount of the regenerative braking.

10. The braking control device of claim 1, wherein the controller is further configured to:
receive a notification of a malfunction of the friction braking system; and
adjust the amount of the regenerative braking based on the notification.

11. A vehicle, comprising:
a regenerative braking system;
a friction braking system;
one or more sensors configured to generate sensor data; and
a controller in communication with the regenerative braking system, the friction braking system, and the sensors, the controller being configured to:
detect a panic braking event initiated by a user;
activate the regenerative braking system to generate an amount of regenerative braking;
monitor an amount of friction braking generated by the friction braking system;
determine rotational speeds of one or more wheels based on the sensor data; and
adjust an amount of the regenerative braking based on the amount of the friction braking and the rotational speeds of the one or more wheels.

12. The vehicle of claim 11, further comprising:
a brake pedal configured to generate a signal indicative of a manner of the user in depressing a brake pedal,
wherein the controller is further configured to detect the panic braking event initiated by the user based on the signal generated by the brake pedal.

13. The vehicle of claim 12, wherein the signal generated by the brake pedal indicates at least one of a moving speed or a moving distance of the brake pedal.

14. The vehicle of claim 11, wherein the controller is further configured to:
adjust magnitudes of regenerative braking torques applied on the one or more wheels based on the rotational speeds of the one or more wheels.

15. The vehicle of claim 11, wherein the controller is further configured to:
adjust the amount of the regenerative braking based additionally on at least one of a state of charge of a battery, a temperature of the battery, a friction coefficient between a wheel and a road surface, or operation property of an electric motor.

16. The vehicle of claim 11, further comprising:
an anti-lock braking system (ABS);
wherein the controller is further configured to:
detect a wheel slip based on the rotational speeds of the one or more wheels; and
activate the ABS to modulate the amount of the friction braking.

17. The vehicle of claim 16, wherein the controller is further configured to:
deactivate the regenerative braking system when the ABS is activated.

18. The vehicle of claim 11, wherein the controller is further configured to:
detect a wheel slip based on the rotational speeds of the wheels; and
reduce the amount of the regenerative braking.

19. The vehicle of claim 11, wherein the controller is further configured to:
receive a notification of a malfunction of the friction braking system; and
adjust the amount of the regenerative braking based on the notification.

20. A computer-implemented method for decelerating a vehicle, the method comprising:
detecting a panic braking event initiated by a user;
activating regenerative braking to decelerate the vehicle;
monitoring an amount of friction braking generated by a friction braking system of the vehicle;
monitoring rotational speeds of one or more wheels of the vehicle;
adjusting an amount of the regenerative braking based on the amount of the friction braking and the rotational speeds of the one or more wheels; and
controlling at least one actuator to apply the adjusted amount of the regenerative braking.
